(19) United States
(12) Patent Application Publication
(10) Pub. No.: US 2021/0059099 A1
(43) Pub. Date: Mar. 4, 2021

(54) WHEEL CARRIER SYSTEM

(71) Applicant: CNH Industrial America LLC, New Holland, PA (US)

(72) Inventors: Leonardo Reis Menezes, Piracicaba (BR); Carlos Henrique Spiacci Correia, Santa Barbara D'Oeste (BR)

(21) Appl. No.: 16/553,093

(22) Filed: Aug. 27, 2019

(51) Int. Cl. A01B 73/00; A01B 63/22

(52) U.S. Cl. CPC A01B 73/00; A01C 7/08; A01B 63/22

(57) ABSTRACT

A system that includes a wheel carrier system. The wheel carrier system includes a wheel carrier arm that couples to a wheel and to a wheel carrier frame. A link rotates a ground engaging tool system with respect to a row unit to transition the ground engaging tool system from a lowered position to a raised position. An actuator that simultaneously rotates the first wheel carrier arm from a first position to a second position and the ground engaging tool system from the lowered position to the raised position.

### BACKGROUND

The present disclosure relates generally to a planting implement.

Generally, planting implements (e.g., planters) are towed behind a tractor or other work vehicle via a mounting bracket secured to a rigid frame of the implement. Planting implements typically include multiple row units distributed across a width of the implement. Each row unit is configured to deposit seeds at a desired depth beneath the soil surface of a field, thereby establishing rows of planted seeds. For example, each row unit typically includes a ground engaging tool or opener that forms a seeding path (e.g., trench) for seed deposition into the soil. An agricultural product conveying system (e.g., seed tube or powered agricultural product conveyor) is configured to deposit seeds and/or other agricultural products (e.g., fertilizer) into the trench. The opener/agricultural product conveying system is followed by closing discs that move displaced soil back into the trench and/or a packer wheel that packs the soil on top of the deposited seeds/other agricultural products. During operation, the planter may operate in two configurations a raised configuration and a lowered configuration. In the raised configuration, the planter lifts the row units to facilitate travel to and from different locations (e.g., fields, maintenance facility). In the lowered configuration, the planter engages the soil with the row units to deposit agricultural product (e.g., seeds, fertilizer). Unfortunately, the increasing number of row units on planters creates torsion on the frame.

### BRIEF DESCRIPTION

In one example, a system that includes a wheel carrier system. The wheel carrier system includes a wheel carrier arm that couples to a wheel and to a wheel carrier frame. A link rotates a ground engaging tool system with respect to a row unit to transition the ground engaging tool system from a lowered position to a raised position. An actuator that simultaneously rotates the first wheel carrier arm from a first position to a second position and the ground engaging tool system from the lowered position to the raised position.

In another example, an agricultural implement system that includes a row unit. The row unit includes a ground engaging tool system that engages the soil with a ground engaging tool. A wheel carrier system couples to the ground engaging tool system. The wheel carrier system includes a wheel carrier arm that couples to a wheel and to a wheel carrier frame. A link rotates the ground engaging tool system with respect to the row unit to transition the ground engaging tool system from a lowered position to a raised position. An actuator simultaneously rotates the wheel carrier arm from a first position to a second position and the ground engaging tool system from the lowered position to the raised position.

In another example, an agricultural implement that includes a toolbar. A row unit couples to the toolbar. The row unit includes a ground engaging tool system that engages soil with a ground engaging tool. A wheel carrier system couples to the toolbar and to the ground engaging tool system. A wheel carrier arm couples to a wheel and to a wheel carrier frame. A link rotates the ground engaging tool system with respect to the row unit to transition the ground engaging tool system from a lowered position to a raised position. An actuator simultaneously rotates the wheel carrier arm from a first position to a second position and the ground engaging tool system from the lowered position to the raised position.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement having multiple row units distributed across a width of the agricultural implement, according to embodiments of the present disclosure;

FIG. 2 is a side view of an embodiment of a row unit in a lowered configuration that may be employed on the agricultural implement of FIG. 1, according to embodiments of the present disclosure;

FIG. 3 is a side view of an embodiment of the row unit of FIG. 2 in a raised configuration, according to embodiments of the present disclosure;

FIG. 4 is a partial side view of the row unit in a lowered configuration, according to embodiments of the present disclosure;

FIG. 5 is a partial side view of the row unit in a raised configuration, according to embodiments of the present disclosure; and

FIG. 6 is a partial bottom view of a row unit, according to embodiments of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection, and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Embodiments of the present disclosure relate generally to a wheel carrier system that transitions an agricultural implement (e.g., row units on the agricultural implement) from a lowered/ground engaging configuration to a raised/transport configuration. The wheel carrier system includes a link that couples to a ground engaging system of the row unit. In operation, the wheel carrier system transfers motion through the link to the ground engaging system. More specifically, the link rotates a ground engaging tool of the ground engaging system away from a wheel on the wheel carrier system. Rotation of the ground engaging tool away from the wheel blocks contact between the ground engaging tool and the wheel as the agricultural implement transitions from a lowered/ground engaging configuration to a raised/transport configuration.

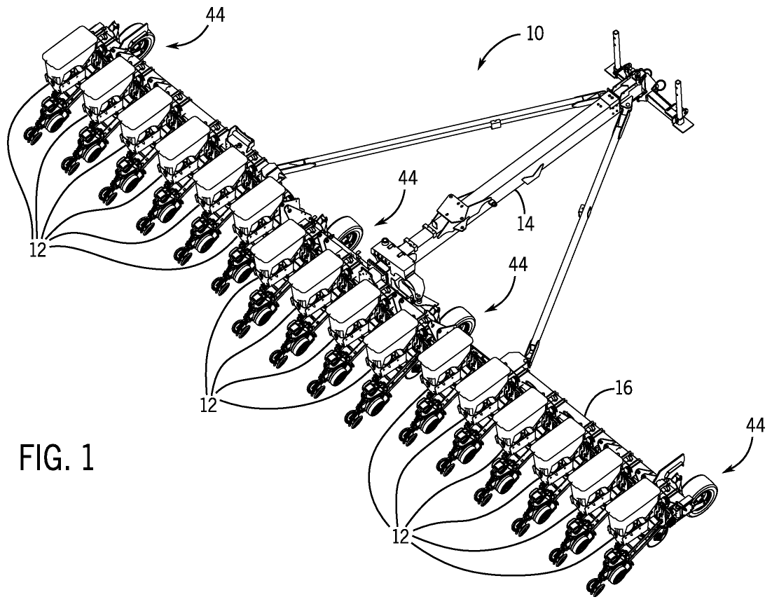

FIG. 1 is a perspective view of an embodiment of an agricultural implement 10 (e.g., planting implement) having multiple row units 12 distributed across a width of the agricultural implement 10. The agricultural implement 10 is configured to be towed through a field behind a work vehicle, such as a tractor. As illustrated, the agricultural implement 10 includes a tongue assembly 14, which includes a hitch configured to couple the agricultural implement 10 to an appropriate tractor hitch (e.g., via a ball, clevis, or other coupling). The tongue assembly 14 is coupled to a frame 16 (e.g., toolbar or toolbars) that supports multiple row units 12. Each row unit 12 may include one or more opener discs configured to form a seed path (e.g., trench) within soil of a field. The row unit 12 may also include an agricultural product conveying system (e.g., seed tube or powered agricultural product conveyer) configured to deposit seeds and/or other agricultural product(s) (e.g., fertilizer) into the seed path/trench. In addition, the row unit 12 may include closing disc(s) and/or a packer wheel positioned behind the agricultural product conveying system. The closing disc(s) are configured to move displaced soil back into the seed path/trench, and the packer wheel is configured to pack soil on top of the deposited seeds/other agricultural product(s).

In order to support the weight of the row units 12 and frame 16, the agricultural system 10 may include a wheel carrier system(s) 44. The wheel carrier system 44 may reduce torsion on the frame 16 created by the weight of the row units 12. The wheel carrier system 44 may also facilitate transition of the agricultural implement 10 from a lowered/ground engaging configuration to a raised/travel configuration depending on the mode of operation of the agricultural implement 10.

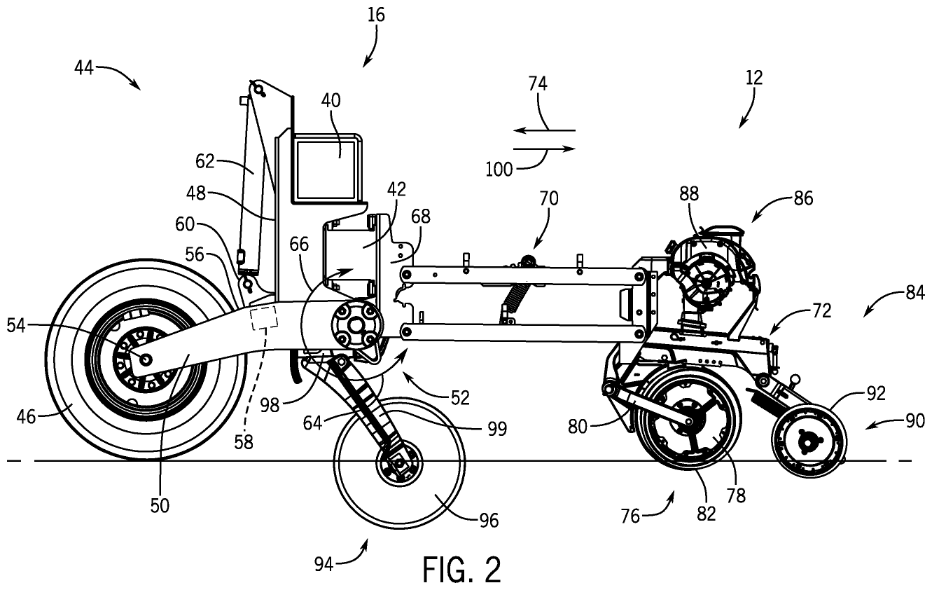

FIG. 2 is a side view of an embodiment of a row unit 12 (e.g., agricultural row unit) that may be employed on the agricultural implement of FIG. 1. As explained above, the row unit 12 includes a frame 18. The frame 18 may include a first tool bar 40 and a second tool bar 42. The first tool bar 40 may be configured to support the wheel carrier system 44, while the second tool bar 42 may be configured to support the row units 12. In order to raise the row units 12, agricultural implement 10 includes the wheel carrier system 44. The wheel carrier system 44 is configured to raise and lower a wheel 46 to transition the agricultural implement 10 (e.g., row units 12) from a lowered/planting configuration to a raised/travel configuration.

The wheel carrier system 44 includes a wheel carrier frame 48 (e.g., housing) that couples to and supports a wheel carrier arm 50 with a rotating connection 52 (e.g., pivot connection). The wheel carrier arm 50 couples to the wheel 46 with a shaft 54. In some embodiments, the wheel carrier system 44 includes another wheel carrier arm 56 (e.g., second wheel carrier arm) that couples to the frame 48 with another rotating connection. The wheel carrier arms 50, 56 are on opposite sides of the wheel 46 and couple together with a shaft or bar 58. The bar 58 may support flanges 60 that enable an actuator 62 to couple to the wheel carrier arms 50 and 56. As illustrated, the actuator 62 couples to the frame 48 and to flanges 60. The actuator 62 may be a hydraulic actuator (e.g., hydraulic piston), pneumatic actuator (e.g., pneumatic piston), electric actuator, or a combination thereof. In operation, the actuator 62 extends and retracts to drive rotation of the wheel carrier arms 50 and 56 with respect to the frame 48. For example, extension of the actuator 62 will drive rotation of the wheel carrier arms 50 and the wheel 46 in direction 64 about the rotating or pivot connection 52. Likewise, retraction of the actuator 62 will rotate the wheel carrier arms 50 and wheel 46 in direction 66 about the rotating connection 52. As the wheel carrier arms 50, 56 rotate in direction 64, the wheel carrier system 44 lifts the frame 16, which then transitions the row unit 12 from a lowered position to a raised position.

The row unit 12 includes a mount 68 configured to secure the row unit 12 to the frame 16 (e.g., second tool bar 42) of the agricultural implement 10. A linkage assembly 70 extends from the mount 68 to a row unit frame 72 of the row unit 12. The linkage assembly 70 is configured to enable vertical movement of the frame 72 relative to the frame 16 in response to variations in a soil surface. In certain embodiments, a down pressure system (e.g., including a hydraulic actuator, a pneumatic actuator) may couple to the linkage assembly 70 and drive the frame 72 toward the soil surface. While the illustrated linkage assembly 70 is a parallel linkage assembly (e.g., a four-bar linkage assembly), in alternative embodiments, another suitable linkage assembly may extend between the mount 68 and the frame 16.

The row unit 12 is configured to deposit seeds and/or other agricultural product(s) at a desired depth beneath the soil surface as the row unit 12 traverses a field along a direction of travel 74. The row unit 12 includes an opener assembly 76 that forms a trench in the soil for seed/other agricultural product deposition into the soil. In the illustrated embodiment, the opener assembly 76 includes gauge wheels 78, arms 80 that pivotally couple the gauge wheels 78 to the frame 72, and opener discs 82. The opener discs 82 are configured to excavate a trench into the soil, and the gauge wheels 78 are configured to control a penetration depth of the opener discs 82 into the soil. In some embodiments, the row unit 12 includes a depth control system 84 configured to control the vertical position of the gauge wheels 78 (e.g., by blocking rotation of the arms in the upward direction beyond a selected orientation), thereby controlling the penetration depth of the opener discs 82 into the soil.

The row unit 12 also includes an agricultural product conveying system 86 (e.g., seed tube or powered agricultural product conveyor) configured to deposit seeds and/or other agricultural product(s) (e.g., fertilizer) into the trench. In some embodiments, the agricultural product conveying system 86 may include a product metering system 88 (e.g., seed meter). The opener assembly 76 and the agricultural product conveying system 86 are followed by a closing assembly 90 that moves displaced soil back into the trench. In the illustrated embodiment, the closing assembly 90 includes two closing discs 92. However, in alternative embodiments, the closing assembly 90 may include other closing devices (e.g., a single closing disc, etc.). In addition, in certain embodiments, the closing assembly 90 may be omitted.

The product metering system 88 is configured to receive agricultural product (e.g., seeds) from a hopper coupled to the row unit 12 and/or from a tube that couples to a product tank on the agricultural implement 10. In certain embodiments, the product metering system 88 may be a vacuum seed meter that includes a disc with multiple openings. An air pressure differential between opposite sides of the disc induces the agricultural product (e.g., seeds) to be captured within the openings. As the disc rotates, the agricultural product is conveyed toward the agricultural product conveying system. When the agricultural product (e.g., seed) is aligned with an inlet to the agricultural product conveying system, the air pressure on each side of the disc is substantially equalized (e.g., at the end of a vacuum passage), thereby enabling the agricultural product (e.g., seed) to enter the agricultural product conveying system (e.g., seed tube or powered agricultural product conveyor). The agricultural product conveying system then directs the agricultural product to the trench. While the illustrated embodiment includes a vacuum seed meter, in alternative embodiments, other suitable seed/agricultural product meters may be utilized. As used herein, “vacuum” refers to an air pressure that is less than the ambient atmospheric air pressure, and not necessarily 0 pa.

As illustrated, the row unit 12 may also include a ground engaging tool system 94 (e.g., a coulter system). The ground engaging tool system 94 may cut plant debris (e.g., roots, stalks) and/or cut a trench to facilitate fertilizer placement in the soil. The ground engaging tool system 94 includes a ground engaging tool 96 (e.g., ground engaging tool). The ground engaging tool 96 couples to a coulter frame 98 with an arm 99. As will be explained below, the coulter frame 98 may pivotally couple to the mount 68 enabling the ground engaging tool system 94 to rotate relative to the mount 68. The ability of the ground engaging tool system 94 to rotate enables the ground engaging tool 96 to rotate away from the wheel 46 as the agricultural implement 10 transitions from a lowered configuration to a raised configuration. In other words, rotation of the ground engaging tool system 94 blocks contact between the wheel 46 and the coulter 96 as the wheel 46 moves in direction 100.

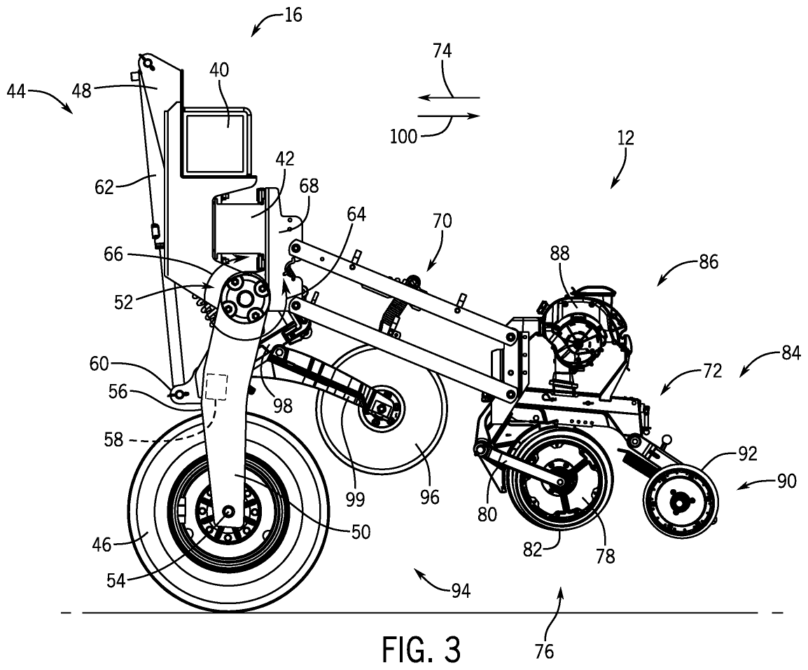

FIG. 3 is a side view of an embodiment of the row unit 12 of FIG. 2 in a raised configuration. As explained above, the actuator 62 extends and retracts to drive rotation of the wheel carrier arms 50 and 56 with respect to the frame 48. In FIG. 3 the actuator 62 is in an extended position. As the actuator 62 extends, the actuator 62 drives rotation of the wheel carrier arms 50, 56 and the wheel 46 in direction 64 about the rotating connection 52. As the wheel carrier arms 50, 56 rotate in direction 64, the wheel carrier system 44 lifts the frame 16 and by extension the row unit 12 from a lowered position to a raised position. In addition to lifting the row unit 12, the wheel carrier system 44 also drives rotation of the ground engaging tool system 94. As explained above, rotation of the ground engaging tool system 94 blocks contact between the wheel 46 and the coulter 96 as the wheel 46 moves in direction 100.

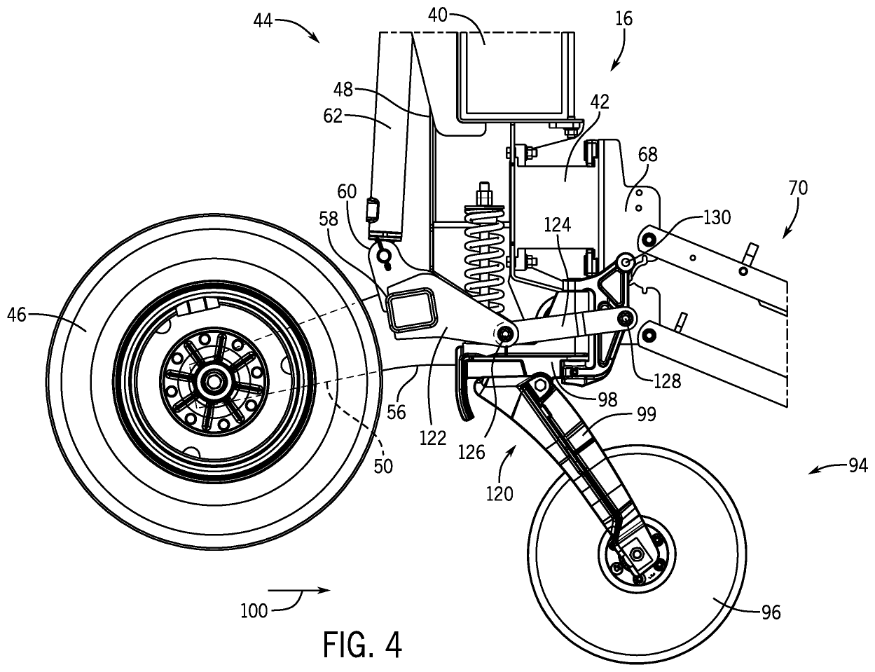

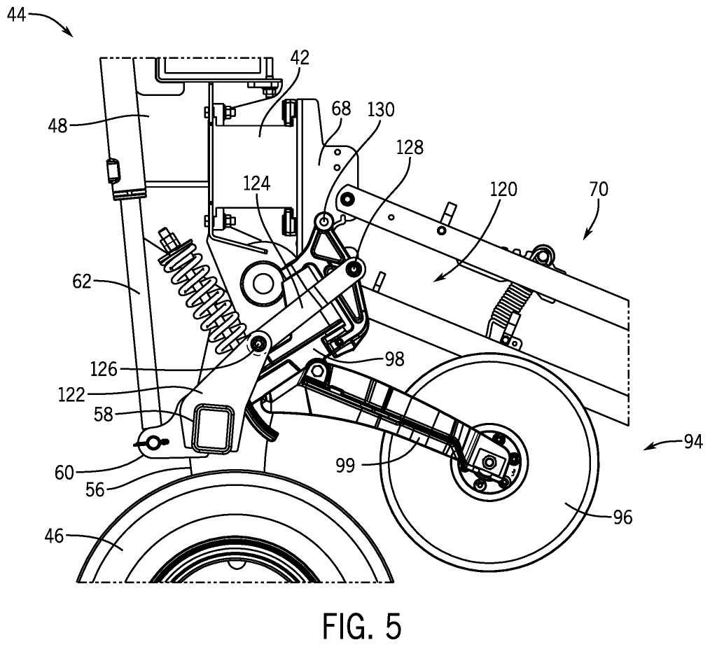

FIGS. 4 and 5 are partial side views of the row unit 12 in respective lowered and raised configurations. In order to rotate the ground engaging tool 96, the wheel carrier system 44 includes a link system 120. The link system 120 includes a flange 122 that couples to the bar 58. A link 124 couples to the flange 122 with a shaft 126 (e.g., pin, bolt) and to the coulter frame 98 with a shaft 128 (e.g., pin, bolt). The shafts 126 and 128 enable the link 124 to rotate relative to the flange 122 and the coulter frame 98. In operation, the wheel carrier arms 50, 56 rotate and drive the bar 58 in direction 100. As the bar 58 moves in direction 100, the flange 122 drives the link 124. Movement of the link 124 in direction 100 rotates the coulter frame 98 about a shaft 130. As illustrated, the shaft 130 (e.g., pin, bolt) pivotally couples the coulter frame 98 to the mount 68. As the coulter frame 98 rotates about the shaft 130, the coulter frame 98 lifts the arm 99 and rotates the ground engaging tool 96 away from the wheel 46 (seen in FIG. 5).

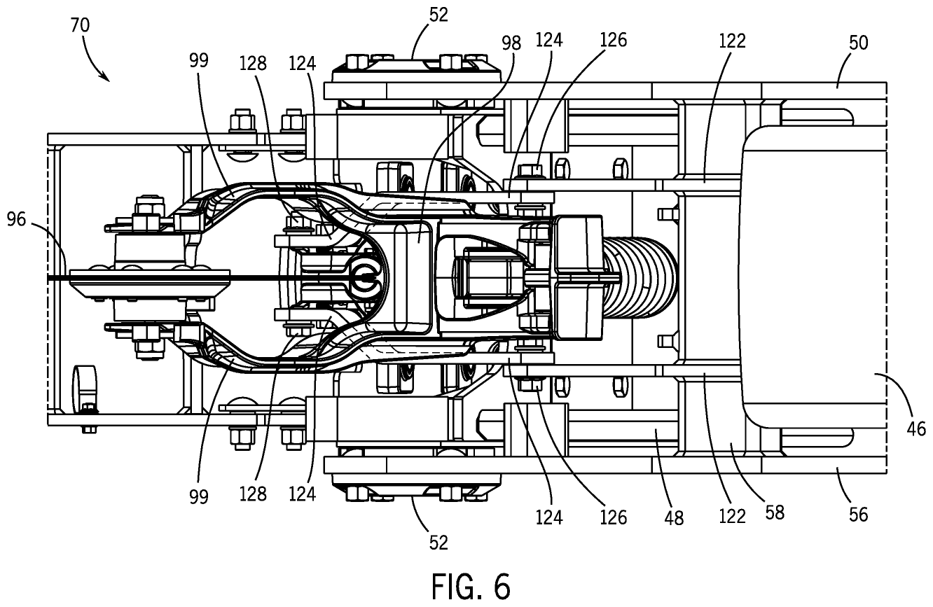

FIG. 6 is a partial bottom view of the wheel carrier system 44 and row unit 12. As illustrated, the wheel carrier system 44 may include wheel carrier arms 50, 56 that couple to the wheel carrier frame 48. The wheel carrier arms 50, 56 support the bar 58, which extends between them. The bar 58 supports the flanges 122 (e.g., 1, 2, or more). For example, the wheel carrier system 44 may include two flanges 122 that provide a connection point for respective links 124. In FIG. 6, the wheel carrier system 44 includes two flanges 122 that support respective links 124. The flanges 122 and links 124 couple together with respective shafts 126 (e.g., pins, bolts) that enable the links 124 to rotate relative to the flanges 122. As explained above, the links 124 couple to the coulter frame 98 with the shaft 128 (e.g., pin, bolt). In operation, the links 124 transfer the movement of the wheel carrier arms 50, 56 to the coulter frame 98. Rotation of the wheel carrier arms 50, 56 therefore drive and rotate the coulter frame 98 away from the wheel 46 by transferring force through the links 124.

Technical effects of the invention include a wheel carrier system that reduces torsion on an agricultural implement. Another effect of the wheel carrier system includes a link system that transfers movement of the wheel carrier system to a ground engaging system to block contact between a wheel of the wheel carrier system and a ground engaging tool of a row unit.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a wheel carrier system, comprising:
a first wheel carrier arm configured to couple to a wheel and to a wheel carrier frame;
a first link configured to rotate a ground engaging tool system with respect to a row unit to transition the ground engaging tool system from a lowered position to a raised position; and
an actuator configured to simultaneously rotate the first wheel carrier arm from a first position to a second position and the ground engaging tool system from the lowered position to the raised position.

2. The system of claim 1, wherein the actuator comprises a hydraulic actuator, pneumatic actuator, electric actuator, or a combination thereof.

3. The system of claim 1, wherein the ground engaging tool system comprises a ground engaging tool frame configured to rotatingly couple to a mount of the row unit and configured to couple to the first link.

4. The system of claim 3, wherein the ground engaging tool system comprises an arm configured to couple to the ground engaging tool frame and to a ground engaging tool.

5. The system of claim 4, wherein the ground engaging tool comprises a coulter disk.

6. The system of claim 1, comprising a second wheel carrier arm configured to couple to the wheel and to the wheel carrier frame, wherein the first wheel carrier arm and the second wheel carrier arm are on opposite sides of the wheel.

7. The system of claim 6, comprising a bar configured to extend between the first wheel carrier arm and the second wheel carrier arm, and wherein the first link is configured to couple to the bar.

8. The system of claim 7, comprising a second link configured to rotate the ground engaging tool system to transition the ground engaging tool system from the lowered position to the raised position, wherein the second link is configured to couple to the bar.

9. The system of claim 1, comprising an agricultural implement, wherein the wheel carrier system is configured to couple to the agricultural implement.

10. The system of claim 9, comprising the row unit, wherein the row unit is configured to couple to the agricultural implement.

11. An agricultural implement system, comprising:
a row unit comprising:
a ground engaging tool system configured to engage soil with a ground engaging tool;
a wheel carrier system coupled to the ground engaging tool system, comprising:
a first wheel carrier arm configured to couple to a wheel and to a wheel carrier frame;
a first link configured to rotate the ground engaging tool system with respect to the row unit to transition the ground engaging tool system from a lowered position to a raised position; and
an actuator configured to simultaneously rotate the first wheel carrier arm from a first position to a second position and the ground engaging tool system from the lowered position to the raised position.

12. The system of claim 11, wherein the actuator comprises a hydraulic actuator, pneumatic actuator, electric actuator, or a combination thereof.

13. The system of claim 11, wherein the ground engaging tool system comprises a ground engaging tool frame configured to rotatingly couple to a mount of the row unit and configured to couple to the first link.

14. The system of claim 13, wherein the ground engaging tool system comprises an arm configured to couple to the ground engaging tool frame and to a ground engaging tool.

15. The system of claim 14, wherein the ground engaging tool comprises a coulter disk.

16. The system of claim 11, comprising a second wheel carrier arm configured to couple to the wheel and to the wheel carrier frame, wherein the first wheel carrier arm and the second wheel carrier arm are on opposite sides of the wheel.

17. The system of claim 16, comprising a bar configured to extend between the first wheel carrier arm and the second wheel carrier arm, and wherein the first link is configured to couple to the bar.

18. The system of claim 17, comprising a second link configured to rotate the ground engaging tool system to transition the ground engaging tool system from the lowered position to the raised position, wherein the second link is configured to couple to the bar.

19. An agricultural implement, comprising:
a toolbar;
a row unit configured to couple to the toolbar, the row unit comprising:
a ground engaging tool system configured to engage soil with a ground engaging tool;
a wheel carrier system configured to couple to the toolbar and to the ground engaging tool system, comprising:
a wheel carrier arm configured to couple to a wheel and to a wheel carrier frame;
a link configured to rotate the ground engaging tool system with respect to the row unit to transition the ground engaging tool system from a lowered position to a raised position; and
an actuator configured to simultaneously rotate the wheel carrier arm from a first position to a second position and the ground engaging tool system from the lowered position to the raised position.

20. The system of claim 19, wherein the actuator comprises a hydraulic actuator, pneumatic actuator, electric actuator, or a combination thereof.
